(19) United States
(12) Patent Application Publication
(10) Pub. No.: US 2025/0226877 A1
(43) Pub. Date: Jul. 10, 2025

(54) RADIO COVERAGE ENHANCEMENT UTILIZING SMART SURFACES ASSISTED UNMANNED AERIAL VEHICLE WITH BEAMFORMING MECHANISM

(71) Applicant: Dell Products L.P., Round Rock, TX (US)

(72) Inventors: Tejinder Singh, Kanata (CA); Navjot Kaur Khaira, Kanata (CA); Erik Boch, Ottawa (CA)

(21) Appl. No.: 18/405,143

(22) Filed: Jan. 5, 2024

(51) Int. Cl. H04B 7/185; H04B 7/04

(52) U.S. Cl. CPC H04B 7/18504; H04B 7/04013

(57) ABSTRACT

A communication system includes a drone and a panel with a reconfigurable intelligent surface. The panel is connected to the drone using flexures that allow the orientation of the panel to be controlled. Changing the orientation of the panel, by controlling or configuring the flexures, allows an incident signal to be reflected in a reflection direction to a target location.

### FIELD OF THE INVENTION

Embodiments of the present invention generally relate to networks and network communications. More particularly, at least some embodiments of the invention relate to systems, hardware, software, computer-readable media, and methods for enhancing or expanding radio coverage using smart surfaces and unassisted aerial vehicles.

### BACKGROUND

Terrestrial communications and networks, while effective and widely used, come with several inherent limitations. Terrestrial networks, for example, are vulnerable to natural disasters such as earthquakes, floods, and hurricanes. These events can damage physical infrastructure, which leads to network outages. More generally, terrestrial networks often struggle to provide coverage in hard-to-reach areas, such as mountainous terrains, deep forests, and rural regions with low population densities. These networks primarily depend on ground-based infrastructure and setting up such infrastructure in such areas can be challenging and economically unfeasible. On the other hand, network congestion can be a significant issue in densely populated urban areas. High demand for data and voice services can lead to a bottleneck effect, reducing the quality of service.

The cost of installing and maintaining physical infrastructure for terrestrial networks is high. While terrestrial networks can provide robust and high-speed connections, they can sometimes struggle with latency issues, particularly over long distances. Some terrestrial networks use reconfigurable intelligent surfaces, which can provide beam steering in some circumstances. In terrestrial networks, however, multiple reflections may be required and this is a challenging and expensive task when terrestrial conditions change. Further, reconfigurable intelligent surfaces can only serve limited areas because they are reflective in nature. Thus, users on only one side of the reconfigurable intelligent surface can be served.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a top view of a panel that includes a reconfigurable intelligent surface;

FIG. 1B discloses aspects of a side view of the panel of FIG. 1A;

FIG. 2A discloses aspects of a communication system including a panel affixed to a drone;

FIG. 2B discloses aspects of reorienting the panel affixed to the drone;

FIG. 3 discloses aspects of a communication system operating in an environment;

FIG. 4 discloses additional aspects of a communication system operating in an urban environment; and

FIG. 5 discloses aspects of a computing device, system, or entity.

### DETAILED DESCRIPTION OF SOME EXAMPLE EMBODIMENTS

Embodiments of the present invention generally relate to enhancing or expanding radio coverage in environments. More particularly, at least some embodiments of the invention relate to systems, hardware, software, computer-readable media, and methods for using reconfigurable intelligent surfaces and unmanned aerial vehicles to enhance or improve radio coverage in environments of different kinds. Embodiments of the invention may be implemented in rural and urban environments by way of example.

Embodiments of the invention relate to deploying unmanned aerial vehicles (e.g., drones), balloons, or the like that are integrated with or joined with reconfigurable intelligent surfaces (hereinafter panels). A panel may be configured control a reflection direction. Stated differently, a panel may be configured to steer or reflect a signal or beam in a particular direction. By deploying UAVs that include a panel, wireless connectivity can be extended to areas or locations that are difficult to reach with traditional terrestrial networks.

Embodiments of the invention may extend connectivity in rural areas or in situations where immediate temporary coverage is needed. Drones with panels can be deployed quickly in response to changing needs and are useful in a variety of different scenarios.

Embodiments of the invention can adapt to changing circumstances, emergencies and are more cost effective compared to building physical infrastructure in areas with challenging terrains or low population densities. Embodiments of the invention can be used to offload traffic from congested terrestrial networks, which may improve service quality in densely populated urban areas. Thanks to the maneuverability and adaptability of drones within a 3D environment, a combination of a panel and a drone can offer comprehensive 360° panoramic reflection across all angles.

As previously stated, terrestrial communication networks often fall short in providing universal wireless connectivity with high-speed data transmission and reliability. To surmount these hurdles and boost network capacity, conventional terrestrial networks have been progressively merging with aerial networks, evolving into integrated air-ground communication systems. In this context, the use of LEO/MEO satellites and high altitude platform systems (HAPS) are in development. These solutions, however, cannot be rapidly deployed.

Embodiments of the invention integrate or combine UAVs and reconfigurable intelligent surface panels to facilitate air-ground communication. These panels may include a large number of low-cost reflecting elements that form a reconfigurable metasurface. These elements can alter the signal propagation environment by adjusting various signal attributes such as amplitude, phase shift, frequency, and polarization. Consequently, reconfigurable intelligent surfaces are capable of reflecting a signal towards its intended recipients. These reconfigurable intelligent surfaces can be used as relay nodes.

In one example, reconfigurable intelligent surfaces are leveraged as a drone payload to amplify coverage and augment performance. The reconfigurable intelligent surfaces mounted on a drone can offer a three-dimensional (3D) panoramic signal reflection for ground users. Concurrently, the drone's mobility lends the reconfigurable intelligent surfaces the ability to be flexibly relocated as needed, enhancing the signal coverage capabilities. In situations like political assemblies, emergency circumstances, concerts, or in challenging terrains such as forests, deserts, and disaster-hit regions, communication (even if temporary) facilitated by panels affixed to drones is a pragmatic and cost-effective solution. Further, embodiments of the invention have the potential to minimize eavesdropping and enhance secure transmission quality.

Embodiments of the invention thus relate to a drone (or other UAV) with a mechanism for holding and/or positioning/orienting a reconfigurable intelligent surface of a panel. This allows radio coverage in an environment to be extended and allows the radio coverage to adapt to changing circumstances.

Drones or UAVs can be autonomously driven by software or manually guided by a ground operator, with no onboard human pilot. Their ease of deployment, adaptability, and maneuverability allow drones to offer services across diverse domains, including security, remote observation, military, photography, logistics, telecommunications, and more. Embodiments of the invention relate to mobile reconfigurable intelligent surfaces that allow multiple types of networks and communications to be extended and enhanced. Embodiments of the invention can provide a substantial likelihood of unobstructed line-of-sight (LOS) with terrestrial nodes, consequently enhancing the speed and dependability of the communication systems.

A reconfigurable intelligent surface of a panel can be active or passive. An active panel may include components such as PIN diodes/varactors. These components may be powered by a battery connected to the panel, using the drone's power source, or using a ground-based power source and a cable. The active panel can be controlled such that the reflection direction is also controlled.

A passive panel does not require a power source. The ability to change the reflection direction, in this example, is achieved by affixing the panel using flexures. With flexures, the orientation of the panel can be changed, which has an impact on the reflection direction. More specifically, a drone may be provided or configured with a mechanism (e.g., arms or flexures) that allow a position or orientation of the panel to be controlled. Changing the position or orientation of the panel can change the direction of the signal reflected by the panel.

Reconfigurable intelligent surfaces affixed on drones can act as mobile relay nodes to enhance the coverage and dependability of terrestrial communication systems. A mmWave (or other wavelength/frequency) reflective surface is formed by a two-dimensional periodic array of unit cells. The metallic pattern of the unit cells may be printed or formed on a cost-effective FR4 or silicon substrate. The reflected beam direction depends on the phase profile of the panel. In other words, the reflection phase from each cell is selected in a manner such that it provides constructive interference in the desired direction. The panel is affixed or carried on the drone using arms/flexures which are attached such that they do not block the view of the cameras on the bottom surface of drone in one example.

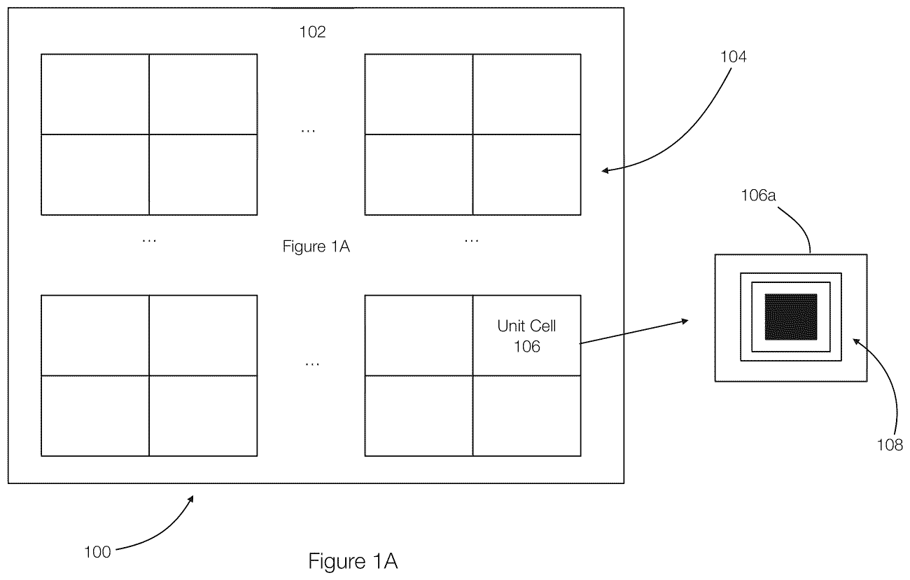

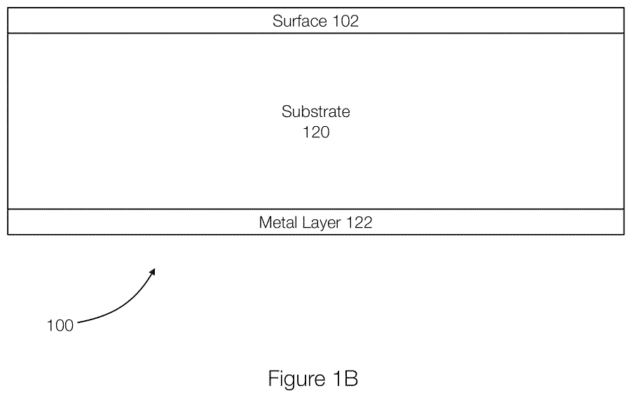

FIG. 1A illustrates a top view of a panel that includes a reconfigurable intelligent surface and FIG. 1B illustrates a side view of the panel. The panel 100 includes a reconfigurable intelligent surface (RIS) 102. In this example, the reconfigurable intelligent surface 102 may be formed over other layers such as a substrate 120 and a metal or metallic layer 122 as shown in FIG. 1B. The metal or metallic layer 122 may reflect an incident signal and the surface 102 is configured to steer the reflected signal or determine the reflection direction.

The substrate 120 may be plastic or other suitable material. More specifically, flexible substrates for reconfigurable intelligent surface applications, including mmWave applications, are generally capable of sustaining high-frequency operations, have low dielectric losses, and demonstrate stability under varying environment conditions. Example substrates may include, but are not limited to, Liquid Crystal Polymer (LCP) and Polyimide and Flexible Glass. LCP offers low water absorption, low dielectric constant, low loss tangent, and excellent dimensional stability. Polyimides are advantageous due to their thermal stability, mechanical robustness, and low dielectric constant. However, their higher water absorption may pose challenges at higher frequencies. For applications requiring additional performance, flexible ultra-thin glass can be used, which provides excellent electrical properties and chemical stability. The metal or metallic layer may be copper or other suitable material. In one example, the metallic layer may be printed on the surface of the substrate.

FIG. 1A more specifically illustrates a top view of the panel 100. This top view illustrates an array 104 of unit cells, represented by the unit cell 106. An enlarged view 106a of the unit cell 106 illustrates a metallic pattern 108. The metallic pattern 108, in this example, includes a solid center portion surrounded by concentric rings. The metallic pattern 108 is sized, shaped or otherwise configured to provide resonance at a particular frequency (or range of frequencies). The metallic patterns 108 of unit cells in the array 104 may be the same or different. Generally, the metallic patterns are configured to generate constructive interference such that the incident beam is reflected in a particular direction.

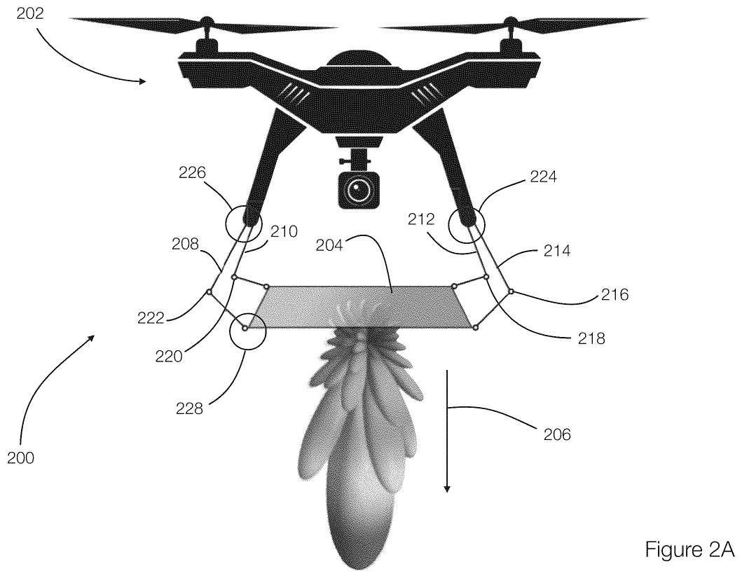

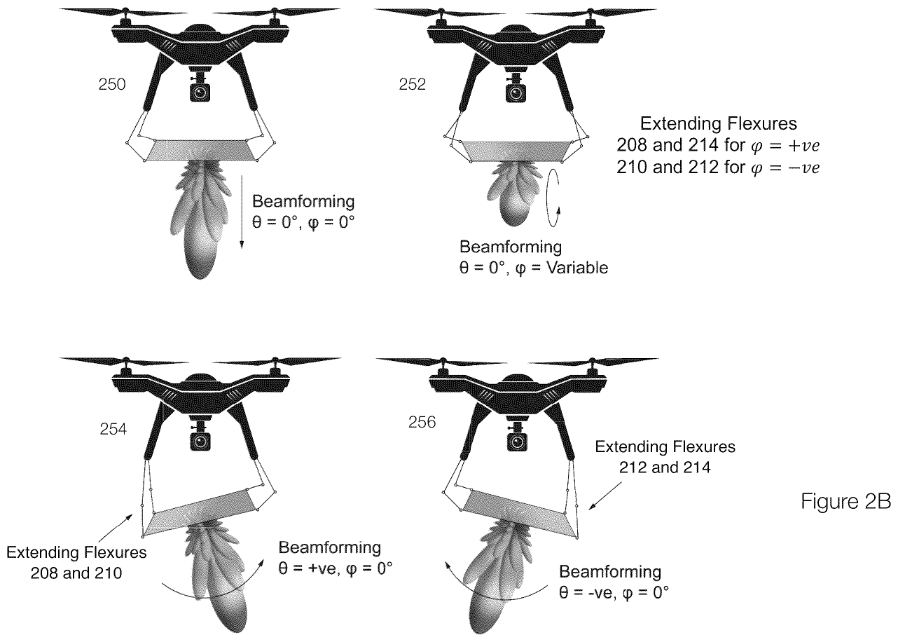

FIG. 2A discloses aspects of a system configured to expand or enhance a network. FIG. 2A illustrates a communication system 200 that includes a drone 202 and a panel 204 with a reconfigurable intelligent surface. The panel 204 is configured with unit cells such that an incident signal or beam is reflected in a certain direction. An example of a beamforming direction 206 is illustrated in FIG. 2A. The panel 204 is connected to the drone 202 using reconfigurable arms or flexures 208, 210, 212, and 214. FIG. 2A illustrates that the panel 204 may be attached or carried as a payload or otherwise connected to the drone 202.

In this example, the panel 204 has a square shape and is sized according to the wavelength to be reflected. The panel 205 may be about 15 cm×15 cm for mmWave signals. Other signals may require larger (or even smaller) dimensions. If this size of the panel 204 interferes with airflow required by the rotors of the drone 202, holes may be formed in the panel 204 to accommodate the necessary airflow.

The panel 204 may be passive or active. Changing the reflection direction in a passive panel requires the panel 204 to be reoriented. This is achieved by activating one or more of the flexures 208, 210, 212, and 214. Changing the orientation of the flexures 208, 210, 212, and 214 changes the azimuth (φ) and elevation (θ) of the panel compared to parallel to ground. Changing the orientation changes the reflection direction of the reflected signal.

More specifically, the flexures 208, 210, 212, and 214 can be moved in various manners (multiple directions) and independently of each other or in concert. In one example, each flexure includes a first portion attached to the drone 202 (e.g., at a pivot 226). The pivot 226 may allow the first portion to move in multiple directions. A second portion of each flexure is connected to the panel, as illustrated by connection 228. The connection 228 may be a clip a key or other connection that allows the panel 204 to be held securely. The two portions of each flexure may be connected by a joint. Thus, each flexure 208, 210, 212, and 214 includes two portions joined by joints 216, 218, 220, and 222.

For example, the joints 216, 218, 220, and 222 can be moved independently. Pivots 224 and 226 (e.g., one pivot for each flexure), which connect the flexures 208, 210, 212, and 214 to a body of the drone 202, may operate in conjunction with the joints 216, 218, 220, and 222 allow each corner of the panel 204 to be raised or lowered independently. Thus, the pivots 224 and 226 and the joints 216, 218, 220, and 220 provide freedom of movement in multiple planes.

The flexures 208, 210, 212, and 214 may be positioned using a battery, a power source of the drone 202, or the like. The flexures 208, 210, 212, and 214 may include a mechanism that allows them to expand or contract. By operating the flexures 208, 210, 212, and 214 independently, in pairs, or the like, the orientation of the panel 204 can be changed as needed.

In another example, the flexures 208, 210, 212, and 214 may be positioned prior to launch. Thus, the panel 204 is oriented with the appropriate azimuth and elevation. If a change to the orientation of the panel 204 is needed, the drone can be flown to ground for the panel orientation adjustment. In this example, the flexures 208, 210, 212, and 214 may not have joints, but may be a length of a material that retains the shape to which it is formed. This allows an orientation of the panel 204, once set by manually configuring the flexures 208, 210, 212, and 214, to remain in place.

FIG. 2B discloses aspects of changing an orientation of a panel affixed to a drone. FIG. 2B, with reference to FIG. 2A, illustrates an orientation 250 of the panel 204. In the orientation 250, θ=0 and φ=0. The orientation 252 illustrates activation of pairs of the flexures. Activating the pair of flexures 208 and 214 or the pair of flexures 210 and 212 allows orientation changes (e.g., +ve or −ve) with respect to φ while holding elevation θ constant.

The orientation 254 illustrates changing the orientation of the panel 204 using the flexures 208 and 210. The orientation 256 illustrates changing the orientation of the panel 204 using the flexures 212 and 214. The orientations 254 and 256 illustrate changes (e.g., +ve or −ve) with respect to θ while holding φ constant. Embodiments of the invention, however, contemplate changes in orientation that include changes to both azimuth and elevation.

More specifically, each of the flexures 208, 210, 212, and 214 can be individually elongated or compressed such that the panel 204 can be tilted or oriented according to requirements. Using four adjustable flexures (other numbers of flexures are within the scope of embodiments of the invention), the reflection, refraction, and phase of the passive reflecting elements in the panel 204 can be adjusted in real time to steer the incident electromagnetic signals in a desired direction. The phase and amplitude of the reflected signal maximizes the effective channel gain in the intended direction as shown in FIG. 2B. The azimuth (φ) and elevation angle (θ) of the reflected beam can be changed by tilting the panel 204 in Y- and X-direction, respectively. When the panel 204 is aligned parallel to the ground, the beamforming direction is in the broadside (θ=0°, φ=0°) as shown in the orientation 250.

When the panel is tilted in Y-direction, the reflected beam is reflected in the direction (θ=0°, φ=variable) as illustrated by the orientation 252. By tilting the panel 204 in the X-direction, the resulting reflected beam is achieved in the direction (θ=variable, φ=0°) as illustrated in the orientations 254 and 256.

The system 200 is thus configured to extend the coverage of terrestrial base stations using a relay in the sky that is capable of passive beamforming. By deploying systems 200 above areas with poor radio coverage (e.g., blockage with respect to a direct path to a base station), radio coverage in those areas is quickly and easily achieved. This is more economical compared to increasing the number of base stations to cover all areas that experience poor radio coverage.

The system 200 allows radio coverage to be enhanced and extended. For example, a signal could be reflected to users that do not have line-of-sight to a base station. Further, the flexures or articulating arms enable a multitude of different panel orientations that allow a signal received from a base station to be redirected to many other directions depending on panel orientation.

The communication system 200 may include a processor, memory, or the like, which may be a controller. These may include modules or components configured to control the flexures and thus control the orientation of the panel 304. The controller may be configured to control operation of the flexures such that the orientation of the panel is controlled. The communication system 300 or controller may be responsive to commands or other input received from a human controller or a computer operating remotely. This may allow the orientation of the panel to be optimized on-the-fly to optimize the reflection direction of the reflected signal.

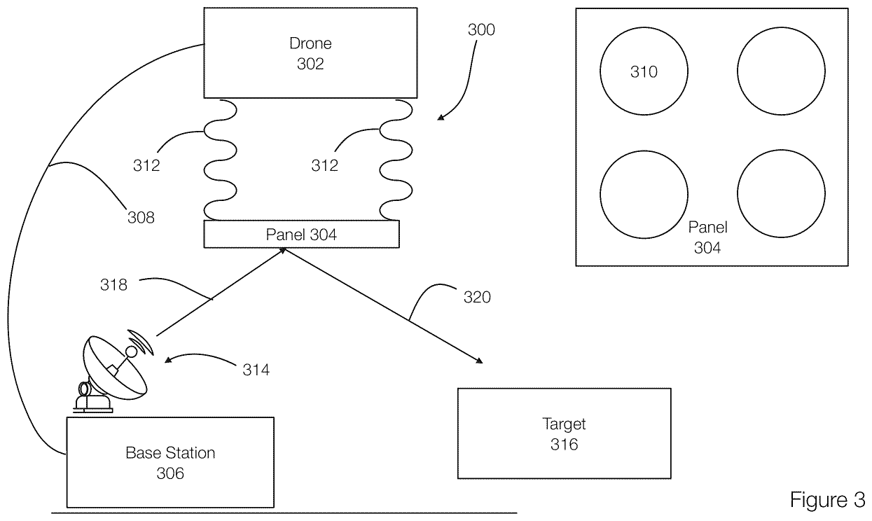

FIG. 3 discloses additional aspects of a communication system. FIG. 3 illustrates a communication system 300 that includes a drone 302 connected with a panel 304 using flexures 312. This example illustrates a terrestrial base station 306 that generates a signal 318, which may be transmitted by an antenna 314. The signal 318 is reflected by the panel 304 as the reflected signal 320 to the target 316. The orientation of the panel 304 may depend on the location of the target 316, the base station 306, and the communication system 300. In this example,

The drone 302 is tethered to the base station 306 by a cable 308. The cable 308 may provide, in one example, power. The elevation of the drone 302 to ground level may depend on the line-of-sight obstructions between the base station 306 and the target 316.

As previously stated, the frequency or wavelength of the signal 318 may impact the size requirements of the panel 304. If necessary, holes 310 may be formed in the panel 304 to accommodate flight requirements of the drone 302 (e.g., rotor airflow). In one example, the cable 308 is not necessary. In this case, the drone 302 has sufficient power for the time requirements associated with the specific situation. Alternatively, additional drones can be used as battery power is consumed. For example, if the drone 302 loses power, the drone 302 can be lowered and the panel 304 can be attached to a new drone and communication can be resumed.

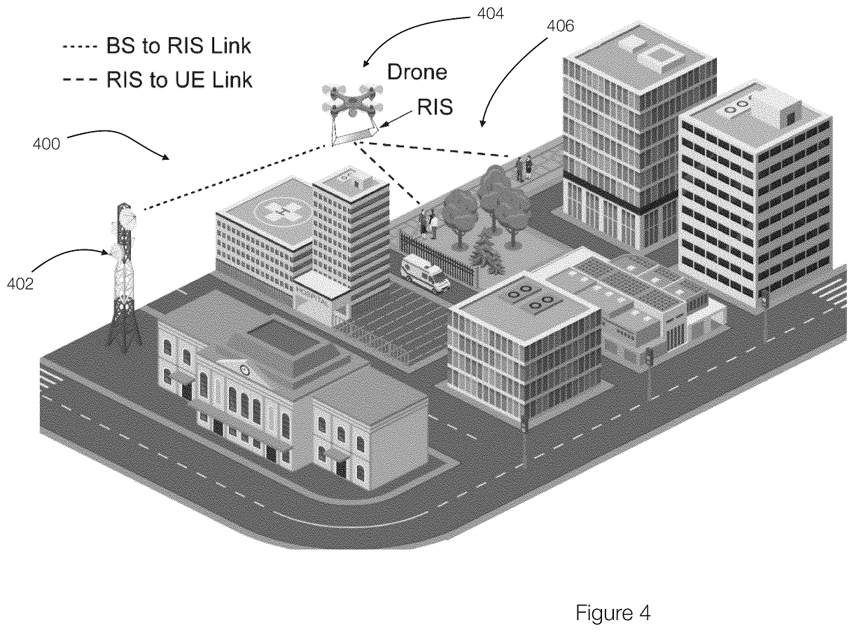

FIG. 4 discloses aspects of extending or enhancing radio coverage in an environment. FIG. 4 illustrates an urban environment 400. In this example, a terrestrial obstruction (e.g., buildings) are present between the base station 402 and a target area 406. The communication system 404, which includes a panel attached to a drone, can reflect a signal from the base station 40-2 to the target area 406.

In urban settings, such as the environment 400, that are characterized by dense high-rise structures, signals often encounter substantial shadowing and blockages. A drone outfitted with a panel (404) could serve as a movable panel, thereby enhancing network coverage in these areas as shown in FIG. 4. In other words, the drone 404 can be relocated as needed and depending on conditions in one example. In one embodiment, the communication system 404 can create optimal or improved link conditions for users in vehicles.

Thus, in situations where a direct connection between a base station 402 and user equipment (UE) is obstructed, a drone equipped with reconfigurable intelligent surface panel, operating at a specific altitude, can act as a relay node.

Embodiments of the invention may be useful in disaster situations that may have impacted existing infrastructure. The destructive impacts of natural disasters often disrupt traditional communication infrastructures, such as mobile, TV, and radio networks. This disruption significantly hinders the response and recovery efforts during disaster scenarios. Drones, due to their accessibility and lightweight structure, are a cost-effective solution for restoring connectivity in these challenging environments. Rapid deployment of these drone-RIS systems, such as the communication system 404, can establish emergency communication networks for mobile, television, radio, or the like, thereby facilitating rescue operations and coordination of relief efforts. These systems can work in synergy with existing emergency technologies like portable cellphone towers or ‘Cell on Wheels’ (COW).

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, communication operations, network coverage operations, radio coverage expansion or enhancement operations, emergency communications operations, or the like. More generally, the scope of the invention embraces any operating environment in which the disclosed concepts may be useful.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A communication system comprising: a drone, a panel that includes a reconfigurable intelligent surface configured to reflect a signal in a reflection direction, and flexures connecting the panel to the drone, wherein the flexures are configured to hold the panel in an orientation such that an incident signal is reflected in the reflection direction to a target location.

Embodiment 2. The communication system of embodiment 1, wherein the flexures comprise a material configured to be manipulated to a position and to hold that position.

Embodiment 3. The communication system of embodiment 1 and/or 2, further comprising a mechanism to connect each of the flexures to a body of the drone in a movable manner.

Embodiment 4. The communication system of embodiment 1, 2, and/or 3, further comprising four flexures, wherein each of the flexures connects to a different corner of the panel.

Embodiment 5. The communication system of embodiment 1, 2, 3, and/or 4, wherein each of the flexures comprises a joint connecting two portions that allows each of the flexures to be expanded and contracted.

Embodiment 6. The communication system of embodiment 1, 2, 3, 4, and/or 5, wherein the reconfigurable intelligent surface is a passive surface configured to reflect mmWave frequencies.

Embodiment 7. The communication system of embodiment 1, 2, 3, 4, 5, and/or 6, wherein the reconfigurable intelligent surface is an active surface configured to reflect mmWave frequencies and wherein power is provided by the drone, a battery, or from a ground power source via a cable.

Embodiment 8. The communication system of embodiment 1, 2, 3, 4, 5, 6, and/or 7, wherein the panel comprises openings to accommodate airflow requirements of the drone.

Embodiment 9. The communication system of embodiment 1, 2, 3, 4, 5, 6, 7, and/or 8, wherein the flexures are repositionable manually and an orientation of the panel is configured by setting the flexures prior to launch of the drone.

Embodiment 10. The communication system of embodiment 1, 2, 3, 4, 5, 6, 7, 8, and/or 9, wherein the flexures are controlled via a controller.

Embodiment 11. The communication system of embodiment 1, 2, 3, 4, 5, 6, 7, 8, 9, and/or 10, wherein an orientation of the panel is changed by activating selected flexures.

Embodiment 12. The communication system of embodiment 1, 2, 3, 4, 5, 6, 7, 8, 9, 10, and/or 11, wherein an azimuth of the panel is changed by activating at least one pair of flexures connected to a first side of the panel to either contract or expand.

Embodiment 13. The communication system of embodiment 1, 2, 3, 4, 5, 6, 7, 8, 9, 10, 11, and/or 12, wherein an elevation of the panel is changed by activating at least one pair of flexures connected to a second side of the panel adjacent to the first side to either contract or expand.

Embodiment 14. The communication system of embodiment 1, 2, 3, 4, 5, 6, 7, 8, 9, 10, 11, 12, and/or 13, wherein the orientation is changed such that the incident signal is reflected to a second target location.

Embodiment 15. The communication system of embodiment 1, 2, 3, 4, 5, 6, 7, 8, 9, 10, 11, 12, 13, and/or 14, wherein a position of the drone is changed such that the incident signal is reflected to a second target location.

Embodiment 16. The communication system of embodiment 1, 2, 3, 4, 5, 6, 7, 8, 9, 10, 11, 12, 13, 14, and/or 15, wherein the incident signal is a cellular signal, a television signal, a radio signal, or a network signal.

Embodiment 17. The communication system of embodiment 1, 2, 3, 4, 5, 6, 7, 8, 9, 10, 11, 12, 13, 14, 15, and/or 16, wherein the reconfigurable intelligent surface comprises unit cells configured to resonate at a particular frequency or range of frequencies.

Embodiment 18. The communication system of embodiment 1, 2, 3, 4, 5, 6, 7, 8, 9, 10, 11, 12, 13, 14, 15, 16, and/or 17, wherein the panel is detachable from and attachable to the flexures.

Embodiment 19. The communication system of embodiment 1, 2, 3, 4, 5, 6, 7, 8, 9, 10, 11, 12, 13, 14, 15, 16, 17, and/or 18, further comprising a plurality of drones that are each associated with a panel.

Embodiment 20. The communication system of embodiment 1, 2, 3, 4, 5, 6, 7, 8, 9, 10, 11, 12, 13, 14, 15, 16, 17, 18, and/or 19, wherein the plurality of drones are deployed to different locations and reflect an incident signal to different target locations.

Embodiment 21. A system, comprising hardware and/or software, operable to perform any of the operations, methods, or processes, or any portion of any of these, disclosed herein.

Embodiment 22. A non-transitory storage medium having stored therein instructions that are executable by one or more hardware processors to perform operations comprising the operations of any one or more operations or methods disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term client, module, component, engine, service, agent, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

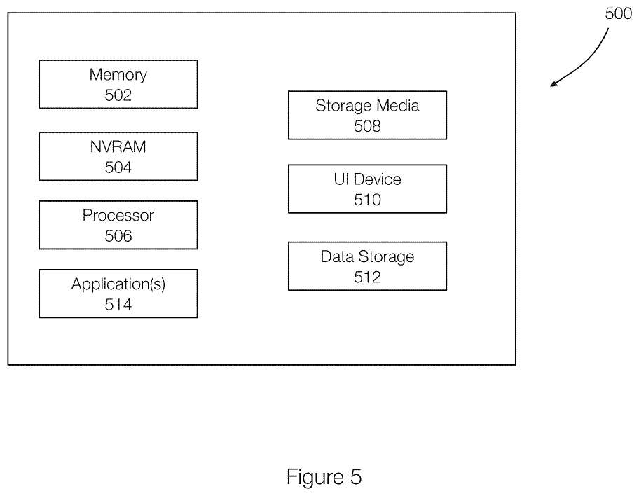

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 501 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A communication system comprising:
a drone;
a panel that includes a reconfigurable intelligent surface configured to reflect a signal in a reflection direction; and
flexures connecting the panel to the drone,
wherein the flexures are configured to hold the panel in an orientation such that an incident signal is reflected in the reflection direction to a target location.

2. The communication system of claim 1, wherein the flexures comprise a material configured to be manipulated to a position and to hold that position.

3. The communication system of claim 1, further comprising a mechanism to connect each of the flexures to a body of the drone in a movable manner.

4. The communication system of claim 1, further comprising four flexures, wherein each of the flexures connects to a different corner of the panel.

5. The communication system of claim 1, wherein each of the flexures comprises a joint connecting two portions that allows each of the flexures to be expanded and contracted.

6. The communication system of claim 1, wherein the reconfigurable intelligent surface is a passive surface configured to reflect mmWave frequencies.

7. The communication system of claim 1, wherein the reconfigurable intelligent surface is an active surface configured to reflect mmWave frequencies and wherein power is provided by the drone, a battery, or from a ground power source via a cable.

8. The communication system of claim 1, wherein the panel comprises openings to accommodate airflow requirements of the drone.

9. The communication system of claim 1, wherein the flexures are repositionable manually and an orientation of the panel is configured by setting the flexures prior to launch of the drone.

10. The communication system of claim 1, wherein the flexures are controlled via a controller.

11. The communication system of claim 1, wherein an orientation of the panel is changed by activating selected flexures.

12. The communication system of claim 11, wherein an azimuth of the panel is changed by activating at least one pair of flexures connected to a first side of the panel to either contract or expand.

13. The communication system of claim 12, wherein an elevation of the panel is changed by activating at least one pair of flexures connected to a second side of the panel adjacent to the first side to either contract or expand.

14. The communication system of claim 1, wherein the orientation is changed such that the incident signal is reflected to a second target location.

15. The communication system of claim 1, wherein a position of the drone is changed such that the incident signal is reflected to a second target location.

16. The communication system of claim 1, wherein the incident signal is a cellular signal, a television signal, a radio signal, or a network signal.

17. The communication system of claim 1, wherein the reconfigurable intelligent surface comprises unit cells configured to resonate at a particular frequency or range of frequencies.

18. The communication system of claim 1, wherein the panel is detachable from and attachable to the flexures.

19. The communication system of claim 1, further comprising a plurality of drones that are each associated with a panel.

20. The communication system of claim 1, wherein the plurality of drones are deployed to different locations and reflect an incident signal to different target locations.
